(19) United States
(12) Patent Application Publication
(10) Pub. No.: US 2024/0099938 A1
(43) Pub. Date: Mar. 28, 2024

(54) ADAPTER DEVICE FOR COUPLING WITH MEDICAL VIALS OF DIFFERENT SIZES

(71) Applicant: B. Braun Melsungen AG, Melsungen (DE)

(72) Inventors: Karl Martin Berg, Melsungen (DE); Johannes Bolz, Kassel (DE); Florin Kopp, Schortens (DE); Christian Walter, Kassel (DE)

(21) Appl. No.: 18/474,449

(22) Filed: Sep. 26, 2023

(30) Foreign Application Priority Data
Sep. 27, 2022 (DE) 10 2022 210 211.8

(51) Int. Cl. A61J 1/20

(52) U.S. Cl. CPC A61J 1/2089; A61J 1/2055

(57) ABSTRACT

An adapter for coupling with medical vials has a housing with a center longitudinal axis. The adapter includes first latching portions on an inner circumference for latching to a first closing cover of a first vial, and second latching portions on the inner circumference for latching to a second closing cover of a second vial. The second closing cover has a larger diameter than the first closing cover. The housing has web portions and spring arm portions extending between the web portions and on which the first latching portions are arranged. The housing is elastically deformable from a first state, in which the spring arm portions latch with the first latching cover, into a second state, in which the spring arm portions allow a latching connection between the second latching portions and the second closing cover. The adapter device can be used in infusion therapy.

### CROSS-REFERENCE TO RELATED APPLICATION(S)

This application claims priority under 35 U.S.C. § 119 to German Application No. 10 2022 210 211.8, filed Sep. 27, 2022, the content of which is incorporated by reference herein in its entirety.

### FIELD

This disclosure relates to an adapter device for coupling with medical vials of different sizes, having a housing with a center longitudinal axis oriented in the axial direction and an inner circumference lying in the radial direction, multiple first latching portions which are each arranged on the inner circumference and configured for latching to a first closing cover of a vial of a first size, and multiple second latching portions which are each arranged on the inner circumference and configured for latching to a second closing cover of a vial of a second size, wherein the first closing cover has a first diameter and the second closing cover has a larger second diameter.

### BACKGROUND

Such an adapter device is known from U.S. Pat. No. 6,875,205 B2. The adapter device has a housing with an inner circumference on which multiple first latching portions and second latching portions are arranged. The first latching portions are configured for latching with a closing cover of a first diameter. The second latching portions are configured for latching with a second closing cover of a larger second diameter. To couple the adapter device with the larger second closing cover, the first latching portions are plastically bent over in the axial direction under the action of the second closing cover, and thereby pressed against the inner circumference of the housing. Because the first latching portions have been plastically bent aside, the second latching portions come into engagement with the second closing cover and latch thereon. The housing of the known adapter device is designed dimensionally stable in comparison with the first latching portions. To this end, material thicknesses in the region of the first latching portions and in the region of the inner circumference of the housing are specially matched to one another to guarantee that only the first latching portions are deformed, and not the entire housing.

Furthermore, DE 10 2020 210 898 A1 discloses an adapter device which can be adapted to different vial sizes, with a housing and elastically spring-movable spring arm portions. The spring arm portions are spring-movable radially inwards and/or outwards by different amounts to adapt the adapter device to vials of different sizes. The spring arm portions are each provided with a latching portion which is used irrespective of the size of vial to be coupled.

### SUMMARY

The object of the disclosure is to provide an adapter device which has improved properties relative to the prior art, and in particular allows simple and reliable coupling with vials of different sizes.

This object is achieved in that the housing has multiple web portions which are offset to one another in the circumferential direction of the housing and each extend axially, and spring-elastic spring arm portions which extend between the web portions and on which at least the first latching portions are arranged, wherein under the axial action of the second closing cover, the housing is elastically deformable starting from a first deformation state, in which the spring arm portions with the first latching portions are arranged relative to the center longitudinal axis for latching with the first latching cover, into a second deformation state, in which the spring arm portions with the first latching portions are spring-elastically shifted radially outward relative to the center longitudinal axis in order to allow a latching connection between the second latching portions and the second closing cover. Because of the solution according to the disclosure, the adapter device can easily and reliably be coupled either with a vial of a first size or with a vial of a second size. To this end, the housing of the adapter device is designed according to the disclosure and comprises said web portions and spring arm portions. The first latching portions are arranged on the spring arm portions for latching to the (smaller) first closing cover. Under the action of the (larger) second closing cover, the spring arm portions with the first latching portions arranged thereon spring radially outward relative to the center longitudinal axis. This allows a latching connection between the second latching portions and the second closing cover. In different embodiments of the disclosure, the second latching portions are arranged at different positions on the inner circumference of the housing. In some embodiments, the second latching portions are arranged on the web portions. In further embodiments, the second latching portions are arranged on the spring arm portions. In different embodiments of the disclosure, a different number of web portions and/or spring arm portions is provided. For example, two, three, four, five, six, seven, eight or even more than eight web portions are provided. The web portions are offset to one another in the circumferential direction. Preferably, the web portions are arranged evenly offset to one another about the center longitudinal axis. Preferably, the statements concerning the number and/or arrangement of the multiple web portions also apply, mutatis mutandis, to the multiple spring arm portions. The web portions each extend axially, preferably parallel to the center longitudinal axis of the housing. The spring arm portions each extend between the web portions. Preferably, the spring arm portions each extend in the circumferential direction of the housing. Preferably, the spring arm portions each extend between a first end and a second end, wherein at least one of the two ends is connected to one of the multiple web portions. Preferably, each end is connected to a web portion, so that the housing is closed as a ring in the circumferential direction. Preferably, the housing is not deformed in the first deformation state, wherein in particular there is no action of the second closing cover. In the second deformation state, at least the spring arm portions are each elastically deformed. In some embodiments, in the second deformation state, also the web portions are each elastically deformed. In further embodiments, there is no or at least no significant elastic deformation of the web portions in the second deformation state. The medical vials of different sizes, in particular their closing covers, are not part of the adapter device according to the disclosure. The medical vials to be coupled are containers for medical substances in liquid or dry state, as are common and generally known in the field of human and veterinary medicine. The design and function of medical vials is familiar to the person skilled in the art, so no further statements are required in this respect. Preferably, the vials of different sizes to be coupled correspond to industry standards ISO 8362-1 and/or ISO 8536-1.

In one embodiment, at least in the first deformation state, the housing—viewed in a direction oriented along the center longitudinal axis—has multiple radially inward bulges offset to one another in the circumferential direction, wherein the radially inward bulges are each formed by a radially inwardly curved wall portion of the spring arm portions and are less pronounced in the second deformation state. The radially inward bulges and/or radially inwardly curved wall portions support the desired elastic deformability of the housing. The radially inward bulges and/or radially inwardly curved wall portions are each convex relative to the inner circumference. In relation to an outer circumference of the housing lying on the outside in the radial direction, the radially inward bulges and/or radially inwardly curved wall portions are each concave. Because of the inwardly bulging design, the housing is not rotationally symmetrical about the center longitudinal axis. In the region of the radially inward bulges and/or radially inwardly curved portions, an inner diameter of the housing—at least in the first deformation state—is smaller than outside the radially inward bulges and/or radially inwardly curved wall portions, in particular in the region of the web portions. In the second deformation state, the radially inward bulges and/or radially inwardly curved wall portions are shifted outward in the radial direction and consequently the bulge and/or curve is less pronounced. In some embodiments, in the second deformation state there is no—or at least no substantial—radially inward bulge of the housing. In some embodiments, in the second deformation state, there is a radial outward bulge of the housing, wherein said wall portions are correspondingly curved radially outward.

In one embodiment, the first latching portions are each arranged on one of the radially inwardly curved wall portions and/or at an apex point of the radially inward bulges. In this embodiment, the first latching portions with the radially inwardly curved wall portions are shifted radially outward on elastic deformation of the housing, in the direction of the second deformation state. Because of the arrangement of the first latching portions at the apex point of the respective radially inward bulge, in particular it is achieved that the respective first latching portion is shifted radially outward while retaining its orientation in the direction of the center longitudinal axis. If arranged outside the apex point, in addition to the radial shift, a change in orientation relative to the center longitudinal axis would take place. In some embodiments, in addition the second latching portions are arranged on the radially inwardly curved wall portions.

In one embodiment, the housing—viewed in the radial direction—has multiple axially inward bulges offset to one another in the circumferential direction and configured for allowing simplified insertion of the respective closing cover, wherein the axially inward bulges are each formed by an axially inwardly curved upper edge of the spring arm portions. The axially inward bulges and/or axially inwardly curved upper edges allow a simplified insertion of the respective closing cover in the housing. Because of the axially inwardly curved upper edges of the spring arm portions, a radial force component is generated under an axial force action, e.g. from the second closing cover. The radial force component causes and/or supports the elastic deformation of the housing in the direction of the second deformation state, i.e. in particular the radially outwardly directed springing of the spring arm portions.

In one embodiment, in the second deformation state, the second latching portions are moved closer together in the radial direction and/or in the circumferential direction of the housing relative to the first deformation state. This embodiment of the disclosure allows a particularly reliable latching of the second latching portions with the second closing cover. In other words, as the second latching portions draw closer together in the radial and/or circumferential direction, the second closing cover is also, under the action of the second latching portions, secured against an unintended release of the latching connection. In this embodiment of the disclosure, the second latching portions are arranged either on one of the web portions or on one of the spring arm portions.

In one embodiment, the housing is closed as a ring in the circumferential direction so as to transmit tensile force, wherein the spring arm portions are each connected at their opposite ends to one of the multiple web portions and the second latching portions are each arranged on one of the multiple web portions. In this embodiment of the disclosure, the spring arm portions are each connected at their mutually opposite ends to one of the multiple web portions. Because the spring arm portions are connected to the web portions at both ends, the housing is closed as a ring in the circumferential direction. In an alternative embodiment, the spring arm portions are connected to one of the multiple web portions only at one end, so that the housing is open (at several points) in the circumferential direction. The second latching portions are each arranged on one of the multiple web portions. Preferably, each of the web portions comprises one of the multiple second latching portions.

In one embodiment, in the second deformation state, the web portions with the second latching portions arranged thereon are each bent inward in the radial direction relative to the first deformation state. Thus, in the second deformation state, the second latching portions are positioned at a smaller distance from the central longitudinal axis in the radial direction than in the first deformation state. The bending deformation of the web portions takes place under the action of the connected spring arm portions. When these are shifted radially outward, starting from the first deformation state in the direction of the second deformation state, because of the design of the housing as a ring in the circumferential direction so as to transmit tensile force, a radially inwardly directed bending stress of the web portions occurs. Because of this bending stress, the web portions with the second latching portions are bent radially inward in the direction of the center longitudinal axis. The web portions are thus bent along their respective longitudinal direction. Preferably, the second latching portions are each arranged at one end on the respective web portion.

In one embodiment, the second latching portions are each arranged on one of the spring arm portions. Preferably, each of the multiple spring arm portions has at least one of the multiple second latching portions.

In one embodiment, in the first deformation state, the second latching portions are oriented pointing away from the center longitudinal axis to allow a latching connection between the first latching portions and the first closing cover, and in the second deformation state, the second latching portions with the spring arm portions are shifted radially outward and are oriented pointing towards the center longitudinal axis for latching to the second closing cover. On a deformation of the housing in the direction of the second deformation state, accordingly firstly the radial position of the second latching portions changes. Secondly, at the same time, their orientation and/or the alignment of the respective longitudinal direction of the second latching portions relative to the center longitudinal axis changes. Because the orientation of the second latching portions is variable under the deformation of the spring arm portions, on deformation in the direction of the second deformation state, these are moved closer together in the circumferential direction of the housing. This embodiment of the disclosure is particularly advantageous in combination with embodiments in which the spring arm portions each have a radially inwardly curved wall portion. Preferably, the second latching portions are each arranged on one of the radially inwardly curved wall portions. The bulge and/or curvature of the radially inwardly curved wall portions changes on deformation in the direction of the second deformation state. Because of the change in bulge and/or curvature, the orientation of the second latching portions arranged on the spring arm portions relative to the center longitudinal axis changes. In the first deformation state, the second latching portions each point away from the center longitudinal axis and/or past this in the radial direction. In other words, in the first deformation state, the second latching portions extend at least substantially perpendicularly to the radial direction and/or tangentially to the inner circumference. This allows the first closing cover with the second latching portions to come into engagement with the first latching portions without collision. In the second deformation state, the second latching portions are in contrast oriented in the direction of the center longitudinal axis and/or extend inwardly in the radial direction. This allows a desired latching of the second latching portions with the second closing cover.

In one embodiment, in each case two second latching portions are arranged in pairs on one of the spring arm portions and on both sides of the first latching portion there. Preferably, the first latching portion is arranged centrally on the respective spring arm portion, wherein the two second latching portions are preferably arranged directly adjacent on sides of the first latching portion which lie opposite one another in the circumferential direction. This embodiment of the disclosure is particularly advantageous in combination with embodiments in which the first latching portions are each arranged on one of the radially inwardly curved wall portions and/or at the apex point of the radially inward bulges. In this case, the pairs of second latching portions are preferably arranged immediately adjacent to the apex point of the radially inward bulge in the circumferential direction. Because of the variable curvature and/or bulge of the radially inwardly curved wall portions under deformation, the orientation of the longitudinal extent of the second latching portions is variable. In simple terms, on a shift in the direction of the second deformation state, the two second latching portions of the pair pivot towards one another about an axially oriented pivot axis extending through the apex point.

In one embodiment, the housing has three web portions which are offset to one another by 120° around the center longitudinal axis. This number and arrangement of the web portions supports the elastic deformation behavior of the housing according to the disclosure. Preferably, each of the three web portions comprises one of the second latching portions. In this case, advantageous, statically determined force ratios apply on latching with the second closing cover.

In one embodiment, the housing has three spring arm portions which are offset to one another by 120° around the center longitudinal axis. This number and arrangement of the spring arm portions supports the elastic deformability of the housing according to the disclosure. Preferably, each of the three spring arm portions comprises one of the first latching portions. In this case, accordingly, advantageous, statically determined force ratios apply on latching with the first closing cover.

In one embodiment, the first latching portions and the second latching portions are positioned differently in the axial direction of the housing so as to match the different axial dimensions of the closing covers. For example, the first closing cover is not as high in the axial direction as the second closing cover. The first and second latching portions are positioned accordingly so as to allow an axially defined coupling with the respective closing cover.

In one embodiment, the housing is made as one piece from a plastic material. This allows a low-cost production in large quantities.

### BRIEF DESCRIPTION OF THE DRAWING FIGURES

Further advantages and features of the disclosure follow from the following description of preferred exemplary embodiments of the disclosure which are illustrated in the drawings.

FIG. 1 shows a schematic, perspective view of an embodiment of an adapter device according to the disclosure;

FIG. 2 shows the adapter device from FIG. 1 in a schematic top view and with a medical vial of a first size;

FIG. 3 is a further schematic, perspective view of the adapter device according to FIGS. 1 and 2;

FIG. 4 shows the adapter device from FIGS. 1 to 3 in a further schematic top view and with a medical vial of a second size;

FIG. 5 is a schematically simplified top view of the adapter device from FIGS. 1 to 4, wherein the housing assumes a first deformation state;

FIG. 6 is a further schematically simplified top view of the adapter device from FIGS. 1 to 5, wherein the housing assumes a second deformation state;

FIG. 7 is a schematic, perspective view of a further embodiment of an adapter device according to the disclosure;

FIG. 8 is a schematic top view of the adapter device from FIG. 7 with a medical vial of a first size;

FIG. 9 is a further schematic, perspective illustration of the adapter device according to FIGS. 7 and 8;

FIG. 10 is a further schematic top view of the adapter device from FIGS. 7 to 9 with a medical vial of a second size;

FIG. 11 is a schematically simplified top view of the adapter device from FIGS. 7 to 10, wherein the housing assumes a first deformation state;

FIG. 12 is a further schematically simplified top view of the adapter device from FIGS. 7 to 11, wherein the housing assumes a second deformation state;

FIG. 13 shows the adapter device from FIGS. 7 to 12 in a schematic side view; and

FIG. 14 shows the adapter device from FIGS. 7 to 13 in a schematically simplified side view to illustrate further features of the housing.

### DETAILED DESCRIPTION

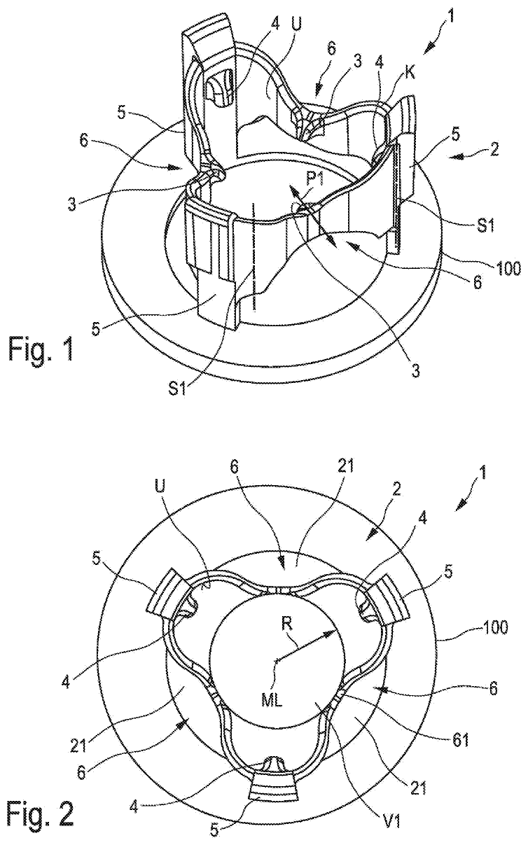

FIGS. 1 to 6 show an adapter device 1 for coupling to medical vials V1, V2 (FIGS. 2, 4) of different sizes.

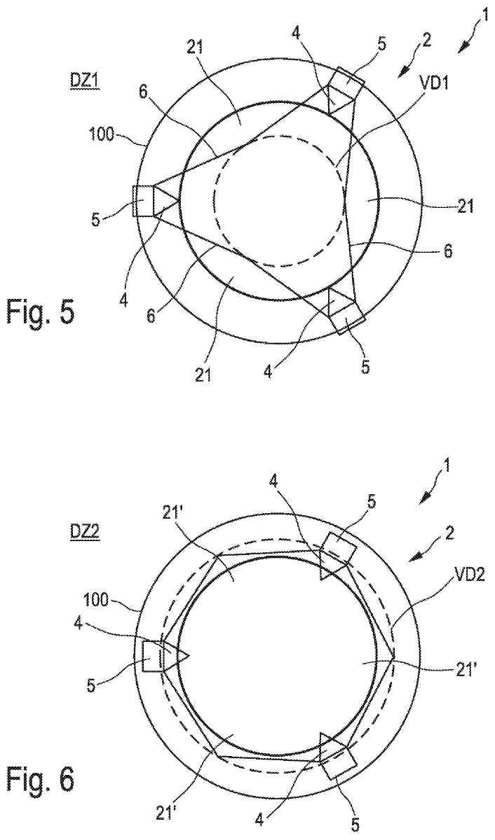

The medical vials V1, V2 of different sizes in this case are vials to industry standard ISO 8362-1 and/or standard ISO 8536-1. Such vials serve to store medical substances in liquid or dry form and are generally known in human and/or veterinary medicine. Vials are also known as ampoules or syringe injection bottles. The vials V1, V2 of different sizes are referred to below as first vial V1 and second vial V2. The vials V1, V2 have different capacities and accordingly different (standardized) dimensions. In particular, the vials V1, V2 have closing covers VD1, VD2 with different diameters, wherein the diameter of the (second) closing cover VD2 of the second vial V2 is greater than the diameter of the (first) closing cover VD1 of the first vial V1. The two closing covers VD1, VD2 are indicated in schematically simplified form in FIGS. 5, 6. Generally, such closing covers are sometimes known closing caps or crimp caps. Since the basic structure and function of the vials V1, V2 are generally known to the person skilled in the art, no further explanations are given here.

The adapter device 1 has a housing 2 and in the present case also an optional carrier plate 100.

The carrier plate 100 is not essential to the present disclosure and accordingly not provided in all embodiments. The carrier plate 100 in this case has a generic design which is purely exemplary.

The adapter device is provided in various embodiments for different applications and accordingly designed differently. For example, in one embodiment, the adapter device is configured as a so-called spike device. In this case, the adapter device has an axially oriented hollow mandrel in the middle of the housing which, in the fashion known to the person skilled in the art, is configured for puncturing said closing cover and is fixed at one end to the carrier plate. In a further embodiment, the adapter device is configured as a closed system transfer device (CSTD) and provided for use in connection with medical substances harmful to health. In this case too, the adapter device comprises a hollow mandrel and in some cases further components, which may for example be arranged on the carrier plate and/or the housing. The features connected with such a specific application of the adapter device are not the main focus of the present case and are not essential with respect to the disclosure. Instead, the focus lies on the housing 2 and its design and function for coupling to the vials V1, V2 of different sizes.

The housing 2 has a central longitudinal axis ML oriented in the axial direction A and an inner circumference U lying on the inside in the radial direction R. Multiple first latching portions 3 and multiple second latching portions 4 are arranged on the inner circumference U of the housing 2.

The latching portions 3 are configured for latching with the first closing cover VD1 (see in particular FIG. 5) of the first vial V1. The second latching portions 4 are configured for latching with the second latching cover VD2 of the second vial V2 (see in particular FIG. 6).

Furthermore, the housing 2 has multiple web portions 5 and multiple spring arm portions 6.

The multiple web portions 5 are offset to one another in the circumferential direction U of the housing 2 and/or around the center longitudinal axis ML. Also, the multiple web portions 5 each extend axially. In the embodiment shown, the web portions 5 are each straight and extend parallel to the center longitudinal axis ML. Furthermore, in the present case, the multiple web portions 5 are each connected at one end to the carrier plate 100, but—as already explained—this need not necessarily be the case.

In the embodiment shown, the multiple web portions 5 are configured identically. Where objective and/or functional features of the multiple web portions are explained below with reference to one web portion only, this disclosure also applies to the further web portions.

The multiple spring arm portions 6 each extend between the web portions 5 and are spring-elastic at least in the radial direction R. In the present case, the spring arm portions 6 are offset to one another in the circumferential direction U of the housing 2 and/or about the center longitudinal axis ML. Furthermore, in the present case, the spring arm portions 6 are each connected at their opposite ends in the longitudinal direction to one of the web portions 5. The longitudinal direction (without reference sign) of the spring arm portions 6 in the present case runs transversely, in particular orthogonally, to the center longitudinal axis ML and/or along the circumferential direction U of the housing 2.

In the embodiment shown, the multiple spring arm portions 6 are configured identically. Where objective and/or functional features of the multiple spring arm portions are explained with reference to one spring arm portion only, the disclosure also applies to the further spring arm portions.

The first latching portions 3 are arranged on the spring arm portions 6, wherein in the present case each spring arm portion 6 comprises a first latching portion 3.

In the embodiment shown in FIGS. 1 to 6, the second latching portions 4 are each arranged on one of the multiple web portions 5. In other words, in the embodiment shown, each web portion 5 comprises a second latching portion 4.

The housing 2 is elastically deformable, in a manner to be described below in more detail, for optional coupling to the (smaller) first vial V1 or to the (larger) second vial V2. For this, either the first latching portions 3 may latch with the first closing cover VD1, or the second latching portions 4 may latch with the second closing cover VD2.

In particular, the housing 2 is elastically deformable under the axial action of the second closing cover VD2, starting from a first deformation state DZ1 (see FIGS. 1, 2, 3, 5) into a second deformation state DZ2 (see FIGS. 4, 6).

In the first deformation state DZ1, the spring arm portions 6 with the first latching portions 3 arranged thereon are positioned relative to the center longitudinal axis ML so as to latch with the first closing cover VD1. The first deformation state DZ1 may also be described as a non-deformed state or starting state.

In the second deformation state DZ2, the spring arm portions 6 with the first latching portions 3 arranged thereon are shifted spring-elastically outward in the radial direction R relative to the center longitudinal axis ML, so that a latching connection is possible between the second latching portions 4 and the second closing cover VD2.

Because of the spring-elastic deformation of the housing 2, its inner diameter (without reference sign) changes. Said inner diameter is smaller in the first deformation state DZ1 than in the second deformation state DZ2, and/or is variable depending on the spring-elastic deflection of the spring arm portions 6 with the first latching portions 3.

In the embodiment shown, the spring arm portions 6 are not precisely straight, or extend for example in the form of a circle cylinder segment. Rather, the spring arm portions 6 have a specific design which supports their spring-elastic movability and hence the elastic deformability of the housing 2.

In the present case, the spring arm portions 6 each have a radially inwardly curved wall portion 61 (see FIG. 2). The radially inwardly curved wall portion 61 curves radially inward in the direction of the center longitudinal axis ML and hence is convex relative to the inner circumference U of the housing. In respect to an outer circumference (without reference sign) of the housing 2, the form is accordingly concave. The radially inwardly curved wall portions 61 of the spring arm portions 6 each form a radially inward bulge 21 of the housing 2 (see FIGS. 2, 5).

The radially curved form of the wall portions 61 and hence the radially inward bulges 21 of the housing 2 are present in at least the first deformation state DZ1. In the second deformation state DZ2, the radially inward bulges 21 are not present or at least are less pronounced than in the first deformation state DZ1. Accordingly, the wall portions 61, which curve radially inward in the first deformation state DZ1, do not curve radially inward in the second deformation state DZ2, or at least have a smaller curvature of the radially inward bulge. FIG. 6 shows that in the second deformation state DZ2, there are radial bulges 21′ which, in the present case, are “outward bulges”. Accordingly, the bulges 21′ in the second deformation state DZ2 are directed radially outward and are concave with respect to the inner circumference U and convex with respect to the outer circumference.

In the embodiment shown, the first latching portions 3 are each arranged on the respective radially inwardly curved wall portion 61 of the respective spring arm portion 6. The latching portions 3 in the present case are arranged on the radially inwardly curved wall portion 61 centrally in the longitudinal direction of the respective spring arm portion 6.

During the spring-elastic deformation of the spring arm portions 6, the first latching portions 3 undergo no, or in any case no practically substantial, elastic deformation. Rather, the first latching portions 3 are only moved outward in the radial direction R. This movement of the first latching portions 3 is a rigid body movement without significant deformation.

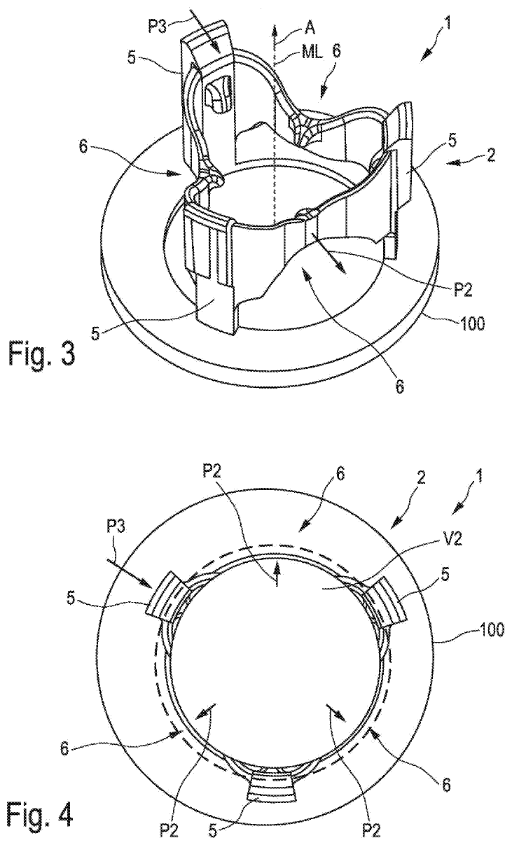

To further illustrate the spring-movability of the spring arm portions 6, reference is made to FIG. 1. The spring arm portion 6 arranged in the foreground of the drawing plane of FIG. 1 is elastically spring-movable radially inward and/or outward along the arrow P1 drawn there. The resulting shift of the spring arm portion 6 may be regarded as a longitudinal bend about the marked bending axes Si in the region of the web portions 5 arranged on both sides of the spring arm portion 6. The bending axes Si in the present case are each parallel to the longitudinal direction of the web portions 5 and/or the center longitudinal axis ML. When the second closing cover VD2 is placed axially on the housing 2 starting from the situation shown as an example in FIG. 1 (first deformation state DZ1), and pressed in the axial direction A in the direction of the carrier plate 100, i.e. downward, the spring arm portions 6 are pressed radially elastically outward under the action of the second closing cover VD2 (see arrow P2 in FIGS. 3, 4). This elastically increases the inner diameter of the housing 2 to receive the second closing cover VD2, and allows a latching engagement between the second latching portions 4 and the second closing cover VD2.

In the embodiment shown, in the second deformation state DZ2, the second latching portions 4 are moved closer together in the radial direction R than in the first deformation state DZ1. This is illustrated in particular by a comparison of FIGS. 5 and 6. In other words, the web portions 5 with the second latching portions 4 arranged thereon are pulled inward in the radial direction R under the action of the radially outwardly springing spring arm portions 6. This is illustrated by the arrows P3 drawn in FIGS. 3 and 4. The outward bulging of the wall portions 61 which curve radially inward in the first deformation state DZ1, and/or the inward bulges 21, load the web portions 5 connected to the spring arm portions 6 with corresponding bearing or reaction forces. As a result, the web portions 5 with the second latching portions 4 arranged thereon are each bent radially inward in the radial direction R. The bend in the present case is a longitudinal bend along the respective longitudinal axis of the web portion 5 concerned.

Because of the present specific design of the adapter device 1 with the carrier plate 100, the web portions 5 are fixedly mounted at one end and free at the other end, so that the deformation behavior of the web portions 5 is comparable in the broadest sense with that of a bar clamped firmly at one end and free at the other. With a different design of the adapter device, which for example provides support of the web portions at both ends, the deformation behavior may accordingly be different.

It is essential for the deformation behavior of the web portions 5 in the embodiment shown in FIGS. 1 to 6 that the spring arm portions 6 are connected at both ends to one of the multiple web portions 5 so as to transmit tensile force, so that the housing has an annular, circumferentially closed design.

Because of the above-mentioned bending movement of the web portions 5 and the resulting radially inwardly directed shift of the second latching portions, a particularly reliable engagement with the second closing cover VD2 in the second deformation state DZ2 is achieved.

In the embodiment shown in FIGS. 1 to 6, the housing 2 has a total of three web portions 5. Also, in total three spring arm portions 6 are provided. The web portions 5 are offset to one another by 120° around the central longitudinal axis ML. The same applies, mutatis mutandis, to the spring arm portions 6.

In further embodiments, the housing has only two web portions or more than the three web portions shown in the present case, for example four, five, six, seven, eight or more web portions. Irrespective of the existing number of web portions, these are preferably offset to one another at even angular distances about the center longitudinal axis.

In embodiments not shown in the figures, also only two or more of the three spring arm portions in the present case are provided. For example, four, five, six, seven, eight or more spring arm portions may be present. The spring arm portions are preferably offset to one another at even angular distances about the center longitudinal axis.

As stated initially, the vials V1, V2 have different capacities and accordingly different dimensions. In particular, the closing covers VD1, VD2 of the vials V1, V2 have said different diameters. In addition, the closing covers VD1, VD2 have different axial dimensions, i.e. thicknesses. In view of the different axial dimensions of the closing covers VD1, VD2, the first latching portions 3 and the second latching portions 4 are positioned differently in the axial direction A of the housing 2. This guarantees that the respective closing cover VD1, VD2 is fixed in the axial direction A on the adapter device 1.

In the present case, the first latching portions 3 are each positioned in the axial direction A closer to the carrier plate 100 than the second latching portions 4. This positioning takes account of the fact that the first closing cover VD1 is thinner in the axial direction A than the second closing cover VD2.

In the present case, the housing 2 is produced as one piece from a plastic material K. This allows economic production in large quantities.

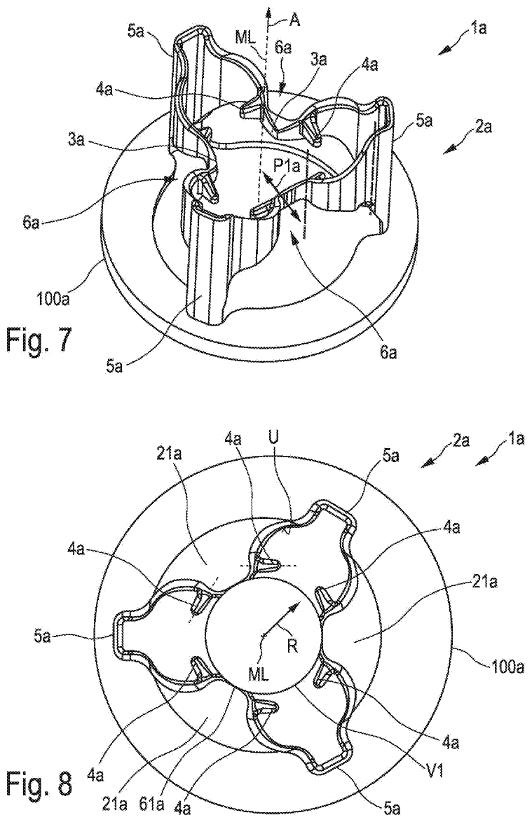

With reference to FIGS. 7 to 14, a further embodiment of an adapter device 1a according to the disclosure is shown. The adapter device 1a according to FIGS. 7 to 14 is largely identical in its design and function to the adapter device 1 from FIGS. 1 to 6. Components and/or portions of the adapter device 1a for which the design and/or function are substantially identical to the adapter device 1 according to FIGS. 1 to 6, are therefore not explained separately. Instead, express reference is made to the corresponding disclosure of the adapter device 1 in FIGS. 1 to 6. The reference signs of substantially identical components and/or portions are supplemented by the lowercase letter “a”. To avoid repetition, only essential differences of the adapter device 1a from the adapter device 1 in FIGS. 1 to 6 are explained below.

The adapter device 1a according to FIGS. 7 to 14 substantially differs from the adapter device 1 in FIGS. 1 to 6 by the arrangement of the second latching portions 4a.

In the adapter device 1a, the second latching portions 4a are arranged on the spring arm portions 6a. Thus, the second latching portions 4a—in contrast to the latching portions 4 of the adapter device 1 in FIGS. 1 to 6—are movable with the spring arm portions 6a on deformation of the housing 2a.

In the embodiment shown, each of the multiple spring arm portions 6a has two second latching portions 4a. The latching portions 4a are arranged in pairs on the spring arm portions 6a. In particular, the pairs of second latching portions 4a are each arranged in the region of the respective radially inwardly curved wall portions 61a of the spring arm portions 6a.

The first latching portions 3a are arranged centrally in the longitudinal direction of the spring arm portions 6a. The second latching portions 4a are each arranged directly on either side of the respective first latching portion 3a in the circumferential direction U. In other words, in each case two second latching portions 4a flank a first latching portion 3a.

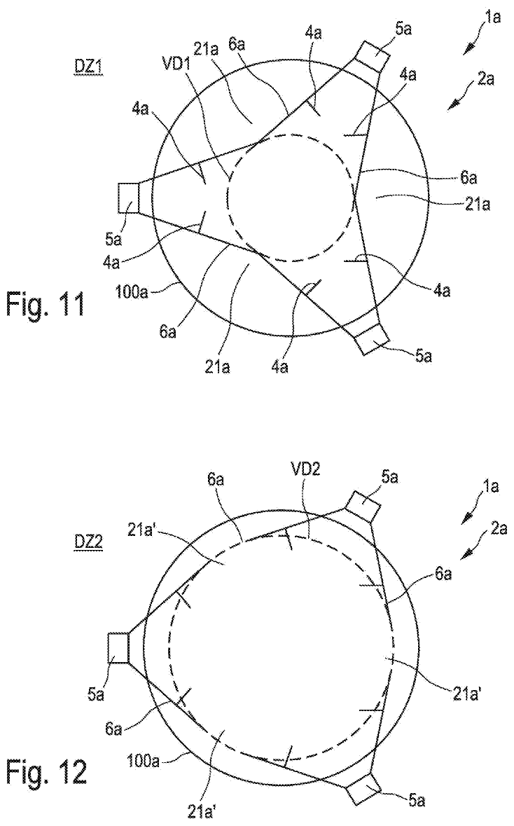

FIGS. 8 and 11 show that the second latching portions 4a are oriented pointing away from the center longitudinal axis ML in the first deformation state DZ1. The second latching portions 4a each extend along a longitudinal axis not designated in more detail. Said longitudinal axes are marked as an example in dotted lines in FIGS. 8 and 10 for two of the multiple second latching portions 4a. In the first deformation state DZ1 (see FIG. 8), the longitudinal axes of the second latching portions 4a point away from the center longitudinal axis ML. In other words, in the first deformation state DZ1, the second latching portions 4a and/or their longitudinal axes do not point approximately radially inward, but instead are oriented at least substantially tangentially and/or orthogonally to the radial direction R.

On a shift in the direction of the second deformation state DZ2, respective pairs of second latching portions 4a are moved closer together in the circumferential direction of the housing 2. Thus, the orientation of the second latching portions 4a and/or the orientation of the respective longitudinal axis changes radially in the direction of the center longitudinal axis ML. In the second deformation state DZ2 (see in particular FIG. 10), the second latching portions 4a each point to the center longitudinal axis ML. The second latching portions 4a and/or their respective longitudinal axes are oriented at least substantially radially.

In the first deformation state DZ1, the second latching portions 4a—which to this extent point tangentially or also laterally away from the center longitudinal axis ML—allow latching of the first latching portions 3a with the first closing cover VD1 (see FIGS. 8, 11). In the second deformation state DZ2, the radially inwardly pointing orientation of the second latching portions 4a allows latching thereof with the second closing cover VD2 (see FIGS. 10, 12). In the first deformation state DZ1, the first latching portions 3a are positioned closer to the center longitudinal axis ML in the radial direction R than the second latching portions 4a. In the second deformation state DZ2, the situation is reversed: the second latching portions 4a are positioned closer to the center longitudinal axis ML in the radial direction R than the first latching portions 3a.

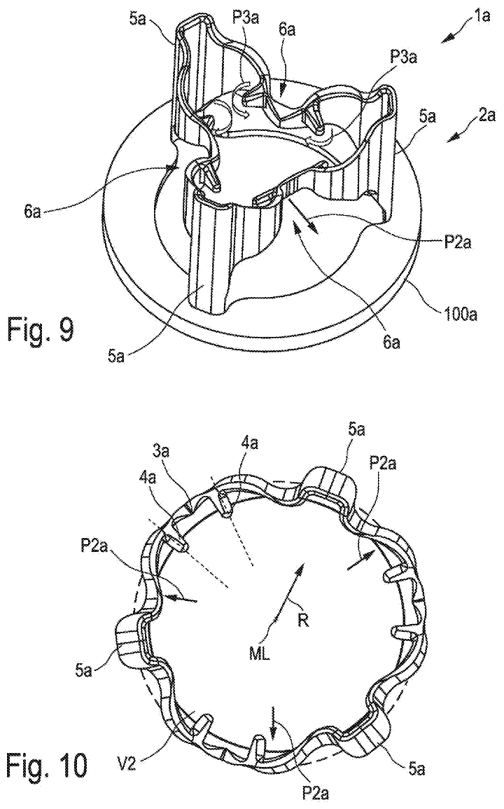

On deformation of the housing 2a in the direction of the second deformation state DZ2, the second latching portions 4a as such are not or at least not substantially elastically deformed. Instead, the second latching portions 4a with the respective spring arm portions 6a are shifted outward in the radial direction R and in addition, because of the deformation-induced change in curvature of the radially inwardly curved wall portions 61a of the spring arm portions 6a, pivoted in the direction of the center longitudinal axis ML. Such a pivot movement is illustrated in FIG. 9 by the arrows P3a.

The schematically simplified side view in FIG. 14 shows that the housing 2a has multiple axially inward bulges 22. The axially inward bulges 22 are formed by a particular design of the upper edges 62a of the spring arm portions 6a. The upper edges 62a are each curved axially inward. The inwardly curved upper edges 62a allow simplified insertion of the respective closing cover VD1, VD2. Under the axial compressive force action of the closing cover VD1, VD2, reaction forces are generated which act outwardly in the radial direction R and support a desired elastic deformation of the housing 2a in the direction of the second deformation state DZ2. The inwardly curved or also sloping upper edges 62a support a sliding of the closing cover VD1, VD2 in the direction of the respective latching position.

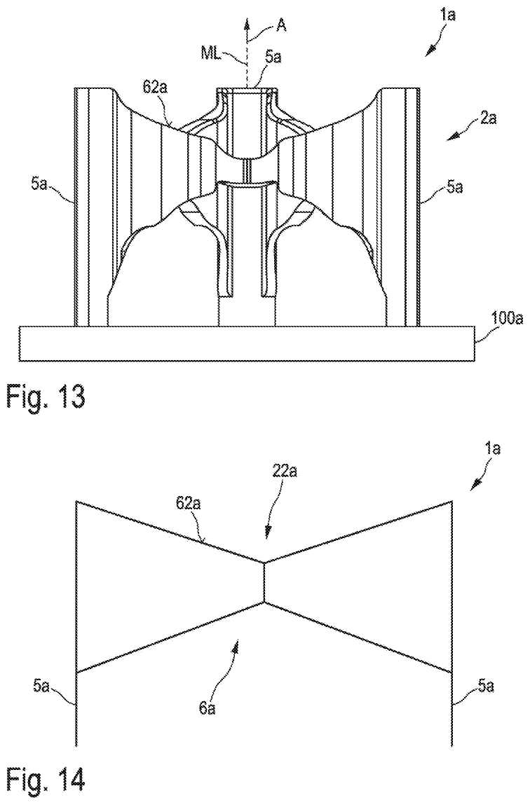

As furthermore shown in particular in FIGS. 13 and 14, the spring arm portions 6a have different dimensions in the axial direction A over their length. In the center, i.e. in the region of the respective first latching portion 3a, the spring arm portions 6a are relatively narrow. At their opposite ends, in the region of the respective web portion 5a, the spring arm portions 6a are relatively wide. This design supports a desired spring-elastic movability of the spring arm portions 6a in the radial direction. At the same time, a sufficient load-bearing capacity in the axial direction A on fitting of the respective closing cover VD1, VD2 is guaranteed.

The additional features explained with reference to FIGS. 13 and 14 and relating to the housing 2a are also present in the housing 2 of the adapter device 1 according to FIGS. 1 to 6.

1. An adapter device for coupling with medical vials of different sizes, the adapter device comprising:
a housing with a center longitudinal axis oriented in an axial direction and an inner circumference;
a plurality of first latching portions that are each arranged on the inner circumference and configured for latching with a first closing cover of a vial of a first size; and
a plurality of second latching portions that are each arranged on the inner circumference and configured for latching with a second closing cover of a vial of a second size,
the housing comprising a plurality of web portions that are offset to one another in a circumferential direction of the housing and each extend axially, and spring arm portions that are spring-elastic and extend between the web portions and on which at least the first latching portions are arranged,
the housing being elastically deformable under axial action of the second closing cover,
the housing being elastically deformable starting from a first deformation state, in which the spring arm portions are arranged relative to the center longitudinal axis for latching with the first closing cover, into a second deformation state, in which the spring arm portions are spring-elastically shifted radially outwardly relative to the center longitudinal axis to allow a latching connection between the second latching portions and the second closing cover.

2. The adapter device according to claim 1, wherein at least in the first deformation state, the housing, viewed in a direction oriented along the center longitudinal axis, has a plurality of radially inward bulges offset to one another in the circumferential direction, wherein the radially inward bulges are each formed by a radially inwardly curved wall portion of the spring arm portions and are less pronounced in the second deformation state.

3. The adapter device according to claim 2, wherein the first latching portions are each arranged on one of the radially inwardly curved wall portions and/or at an apex point of the radially inward bulges.

4. The adapter device according to claim 1, wherein the housing, viewed in a radial direction, has a plurality of axially inward bulges offset to one another in the circumferential direction and configured for allowing simplified insertion of the respective closing cover, wherein the axially inward bulges are each formed by an axially inwardly curved upper edge of the spring arm portions.

5. The adapter device according to claim 1, wherein, in the second deformation state, the second latching portions are moved closer together in the radial direction and/or in the circumferential direction of the housing relative to the first deformation state.

6. The adapter device according to claim 1, wherein the housing is closed as a ring in the circumferential direction so as to transmit tensile force, wherein the spring arm portions are each connected at opposite ends to one of the web portions, and wherein the second latching portions are each arranged on one of the web portions.

7. The adapter device according to claim 6, wherein, in the second deformation state, the web portions with the second latching portions arranged thereon are each bent inward in the radial direction relative to the first deformation state.

8. The adapter device according to claim 1, wherein the second latching portions are each arranged on one of the spring arm portions.

9. The adapter device according to claim 8, wherein, in the first deformation state, the second latching portions are oriented pointing away from the center longitudinal axis to allow a latching connection between the first latching portions and the first closing cover, and wherein in the second deformation state, the second latching portions with the spring arm portions are shifted radially outward and are oriented pointing towards the center longitudinal axis for latching to the second closing cover.

10. The adapter device according to claim 8, wherein the second latching portions are arranged in pairs on one of the spring arm portions and on both sides of the first latching portion.

11. The adapter device according to claim 1, wherein the housing has three web portions that are offset to one another by 120° around the center longitudinal axis.

12. The adapter device according to claim 1, wherein the housing has three spring arm portions that are offset to one another by 120° around the center longitudinal axis.

13. The adapter device according to claim 1, wherein the first latching portions and the second latching portions are positioned differently in the axial direction of the housing so as to match different axial dimensions of the closing covers.

14. The adapter device according to claim 1, wherein the housing is made as one piece from a plastic material.
